(19) United States
(12) Patent Application Publication
(10) Pub. No.: US 2015/0317681 A1
(43) Pub. Date: Nov. 5, 2015

(54) MERCHANT CUSTOMER SHARING SYSTEM

(71) Applicant: EBAY INC., San Jose, CA (US)

(72) Inventors: Kamal Zamer, Austin, TX (US); Praveen Nuthulapati, Austin, TX (US)

(21) Appl. No.: 14/266,117

(22) Filed: Apr. 30, 2014

(51) Int. Cl. G06Q 30/02

(52) U.S. Cl. CPC G06Q 30/0261; G06Q 30/0269; G06Q 30/0275; G06Q 30/0273

(57) ABSTRACT

Systems and methods for sharing customer traffic between merchants include a system provider device that may establish an alliance between a first merchant at a first merchant location and a second merchant at a second merchant location. The system provider device detects events associated with the first merchant that satisfy one or more merchant activity rules. The system provider may also determine an availability of the second merchant to service one or more customers. Thereafter, the system provider device refers at least one customer at the first merchant location to the second merchant at the second merchant location. In addition, the system provider device may receive bids from a plurality of allied merchants for the referral of the at least one customer, may credit a first merchant account based on a transaction with a referred customer at the second merchant location, and may recognize opportunities for merchant alliances.

### BACKGROUND

1. Field of the Invention

The present disclosure generally relates to merchants, and more particularly to a customer sharing system that provides for allied merchants to share customer traffic.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment service providers provide online and mobile payment services for merchants with merchant physical locations and their customers in order to allow the customers to make purchases from the merchants at the merchant physical locations. When deciding upon a particular merchant physical location (e.g., a restaurant) to visit, customers may make their decision based at least partly on how long the service experience at the merchant physical location will last (e.g., including wait time to place an order, wait time to receive the order, and/or times associated with a variety of other service experience factors known in the art). During periods of high customer traffic at a merchant, customer wait times may be quite long. In one example, during a peak business hour (e.g., lunch hour), customers may not have the time or inclination to wait longer than a few minutes at a merchant location. Consequently, some customers may be willing to patronize an alternative, nearby merchant location offering an equivalent or complementary service and/or product in order to minimize the total time of their service experience. However, as willing as some customers may be to take advantage of such an alternative merchant, customers may not be aware of the nearby merchant location. For example, customers may be unaware of a nearby, but hard to find, merchant. In other examples, customers may be aware of a nearby merchant, but they may be unaware that there is little to no wait time for service at the nearby merchant.

Thus, there is a need for a customer sharing system that provides merchants the ability to share customer traffic and improve the experience of customers with those merchants.

### BRIEF DESCRIPTION OF THE FIGURES

FIG. 1 is a schematic view illustrating an embodiment of a customer sharing system;

FIG. 2 is a schematic view illustrating an embodiment of a beacon device;

FIG. 3A is a schematic view illustrating an embodiment of the customer sharing system of FIG. 1 that includes a plurality of the beacon devices of FIG. 2;

FIG. 3B is a schematic view illustrating an embodiment of the customer sharing system of FIG. 3A with the beacon devices providing communication areas;

FIG. 4 is a schematic view illustrating an embodiment of a system provider device connected to beacon devices in the customer sharing system of FIG. 3 and to customer database and merchant physical location databases to provide a customer sharing system;

FIG. 5 is a flow chart illustrating an embodiment of a method for sharing customer traffic between merchants;

FIG. 6 is a schematic view illustrating an embodiment of a customer sharing system including two merchants having a first distribution of customers;

FIG. 7 is a front view illustrating an embodiment of a customer device displaying an allied merchant alert;

FIG. 8 is a schematic view illustrating an embodiment of a customer sharing system including two merchants having a second distribution of customers;

FIG. 9 is a schematic view illustrating an embodiment of a networked system;

FIG. 10 is a perspective view illustrating an embodiment of a customer device;

FIG. 11 is a schematic view illustrating an embodiment of a computer system; and

FIG. 12 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing a customer sharing system which allows merchants to effectively and advantageously share customer traffic. By way of example, the systems and methods described herein provide for a plurality of merchants to maintain a more steady stream of customers by referring customers at busy merchants (e.g., having long wait times) to more available merchants (e.g., having comparably shorter wait times), thus improving customer experiences while keeping customers within a merchant ecosystem. In some embodiments, merchants sharing customers may be “allied” such that they participate in the customer sharing system. As used herein, the terms “allied merchant” or “allied merchants” may refer to two or more merchants that have agreed to refer customers to one another for example, under certain conditions which may be defined by one or more merchant activity rules. In some cases, a referral fee may be paid to the referring merchant, and in some cases such a referral fee may be contingent on completion of a customer purchase at the merchant location to which the customer was referred. Also, as used herein, the term “merchant activity rule” may describe one or more merchant-defined rules that may trigger (either automatically or manually) a referral of a customer to another merchant. Some examples of merchant activity rules may include referral of one or more customers to another merchant when a number of merchant transactions exceeds a particular number of transactions per minute (e.g., 5 transactions per minute), when a customer wait time exceeds a certain time (e.g., 10 minutes), when there are more than a certain number of customers waiting (e.g., more than 10 customers waiting), and/or other customizable, merchant-defined activity rules. Additionally, the term “allied merchant ecosystem” may describe a network of merchants that have agreed to be allied to one another, both for the purpose of sharing customer traffic (and thus mitigating costly downtimes) and in order to improve customer service experiences.

Conventionally, customers desiring to patronize a first merchant location may be willing to patronize an alternative, nearby second merchant location that is offering an equivalent or complementary service and/or product to the first merchant location; however, such customers may not always be aware of the nearby second merchant location. Additionally, while some customers may be aware of an alternative, nearby merchant, they may be unaware that the alternative, nearby merchant can readily service more customers. Thus, in accordance with the various embodiments described herein, merchants may be able to avoid spikes of busy/slow times and instead maintain a steady stream of customer traffic by allying with each other. Further, embodiments described herein facilitate keeping customers within the allied merchant ecosystem, which can help to maintain revenues within a network of allied merchants. Moreover, the improved customer experiences may also encourage repeat customer traffic to one or more of the allied merchants.

In some examples, the merchants described herein may offer competing products and/or services, and in other examples, the merchants may offer complementary products and/or services. One of skill in the art in possession of the present disclosure will recognize that a wide variety of merchants, providing many different types of goods and/or services, will benefit from the systems and methods discussed below, and thus will fall within the scope of the present disclosure. In various examples, an alliance between a first merchant at a first merchant location and a second merchant at a second merchant location is established, where the alliance includes a definition of one or more merchant activity rules. The system provider may detect events that are associated with the first merchant and that satisfy one or more of the merchant activity rules. The system provider may then determine the availability of the second merchant to service one or more customers. Thereafter, based on the detected events that are associated with the first merchant and that satisfy the one or more merchant activity rules, and on the availability of the second merchant, at least one customer at the first merchant location may be referred to the second merchant at the second merchant location. As described in more detail below, the system provider may also receive bids from one or more of a plurality of merchants for the referral of the at least one customer, may credit a first merchant account associated with the first merchant based on a transaction with a referred customer that is processed at the second merchant location, may analyze location histories of customers to recognize customer groups, may recognize opportunities for merchant alliances, as well as provide for various other functionality as described herein.

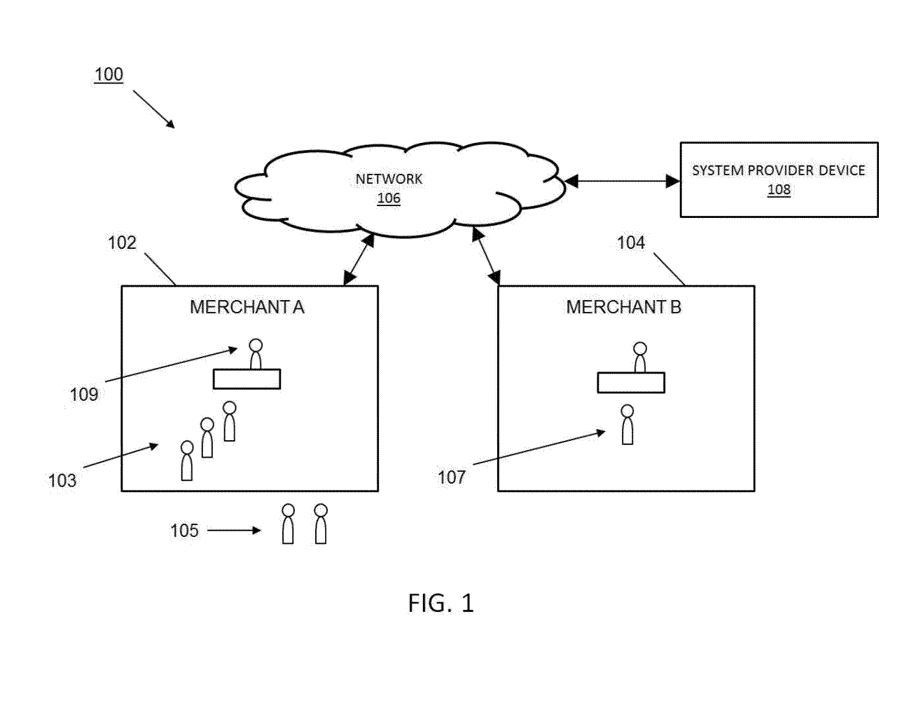

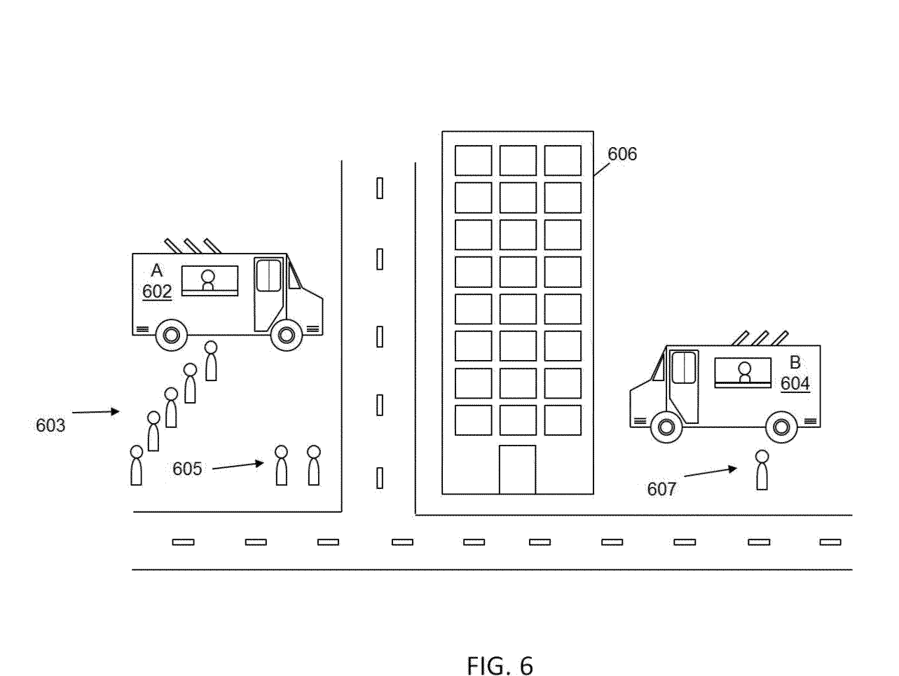

Referring now to FIG. 1, an embodiment of a customer sharing system 100 is illustrated. The customer sharing system 100 includes a first merchant 102 (illustrated and equivalently referred to as “Merchant A”) having a first merchant physical location and a second merchant 104 (illustrated and equivalently referred to as “Merchant B”) having a second merchant physical location. Each of the first merchant 102 and the second merchant 104 include one or more merchant devices that are coupled to a network 106 that is further coupled to a system provider device 108. For example, the first merchant 102, the second merchant 104, and the system provider device 108 are configured to communicate with one another by way of the network 106, for example by way of network communication devices, as discussed below. In the embodiments illustrated and discussed below, each of the first merchant 102 and/or the second merchant 104 may provide separate restaurants. However, one of skill in the art in possession of the present disclosure will recognize that the customer sharing system 100 described herein may be utilized with virtually any merchant type located at virtually any merchant physical location such as, for example, a department/grocery store, a pharmacy, a movie theater, a theme park, a sports stadium, and/or a variety of other merchant physical locations known in the art. Moreover, in some embodiments, the first and second merchant 102, 104 physical locations may include a mobile merchant location such as a food truck, cart, kiosk, trailer, and/or other mobile merchant location as known in the art. For example, with reference to the embodiments of FIGS. 6-8, each of the first and second merchant 102, 104 physical locations include separate food trucks, as discussed in further detail below.

The network 106 may be implemented as a single network or a combination of multiple networks. For example, in various embodiments, the network 106 may include the Internet and/or one or more intranets, landline networks, wireless networks, cellular networks, satellite networks, and/or other appropriate types of networks. In some examples, the first merchant 102 and/or the second merchant 104 may communicate through the network 106 via cellular communication, by way of one or more merchant network communication devices. In other examples, the first merchant 102 and/or the second merchant 104 may communicate through the network 106 via wireless communication (e.g., via a WiFi network), by way of one or more merchant network communication devices. In yet other examples, the first merchant 102 and/or the second merchant 104 may communicate through the network 106 via any of a plurality of other radio and/or telecommunications protocols, by way of one or more merchant network communication devices. In still other embodiments, the first merchant 102 and/or the second merchant 104 may communication through the network 106 using a Short Message Service (SMS)-based text message, by way of one or more merchant network communication devices.

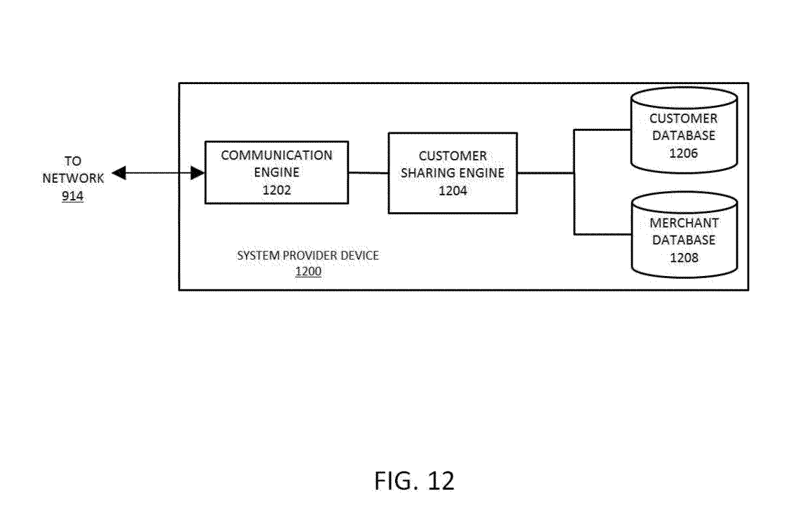

The system provider device 108 may likewise couple to the network 106 via a wired or wireless connection. As described in more detail below with reference to FIG. 12, the system provider device 108 may include a customer sharing engine, a communication engine, a merchant information database, and a customer database. Software or instructions stored on a computer-readable medium, and executed by one or more processors of the system provider device 108, allows the system provider device 108 to send and receive information over the network 106. Furthermore, the customer sharing engine in the system provider device 108 may be configured to implement the various embodiments of the customer sharing system as described herein. In some examples, the system provider device 108 is configured to establish and maintain merchant alliances among two or more merchants, including triggering customer referrals based at least partly on merchant activity rules.

In the embodiment illustrated in FIG. 1, a plurality of customers 103 may be waiting for service at the Merchant A physical location when additional customers 105 arrive at the Merchant A physical location. Arrival of the additional customers 105 may be detected by way of one or more beacons, as discussed below, and in some embodiments may satisfy a merchant activity rule (e.g., defined by Merchant A) which may specify, for example, a threshold number of customers Merchant A is able to serve, and above which any additional customers should be referred to Merchant B if Merchant B has availability to serve those additional customers. In the present example, Merchant B only has one customer 107 and thus can accommodate additional customers referred from Merchant A. In other embodiments, the additional customers 105 may not immediately be referred to Merchant B until a different, specific merchant activity rule is satisfied by Merchant A. For example, if at some point the customer wait time exceeds an amount of time (e.g., 10 minutes) at the Merchant A location, one or more customers (e.g., the additional customers 105) may be referred to Merchant B. In other examples, if a number of transactions at the Merchant A location exceeds a specified number of transactions per minute, then one or more customers (e.g., the additional customers 105) may be referred to Merchant B. In yet other examples, a merchant 109 at the Merchant A location may manually refer one or more customers to the Merchant B location, such as when Merchant A is running low on available items, when Merchant A wants to take a break, when Merchant A experiences a problem that affects Merchant A's ability to deliver offered items, or any other reason Merchant A may want to start sending customers to Merchant B.

Merchant activity rules may be defined by the system provider, any merchant participating in the customer sharing system, and in some cases, in conjunction with rules specified by customers. For example, Merchant A may specify the number of customers, the wait time, and the transactions per minute that must be exceeded by Merchant A before a customer will be referred to another merchant. In addition, Merchant B may specify a number of customers, a wait time, and a transactions per minute that must not be exceeded by Merchant B before a customer may be referred to another merchant. Furthermore, customers may specify a wait time for Merchant A that must be exceeded before they will be referred to another merchant. As such, merchant activity rules may include any combination of rules defined by the merchant from which customers are to be referred, the merchant to which customers will be referred, and the customers that will be referred. While a few examples of merchant activity rules have been described which would trigger referral of one or more customers from a first merchant location (e.g. Merchant A location) to a second merchant location (e.g., Merchant B location), one of skill in the art will recognize that other merchant activity rules may be implemented in the merchant alliance system 100, while remaining within the scope of the present disclosure.

In some embodiments, the system provider device 108 is further configured to provide customer referrals to any of a plurality of allied merchants based at least partly on a bidding process among a plurality of allied merchants (e.g., Merchant B, a Merchant C (not shown), and/or a variety of other allied merchants may bid for referral of the additional customers 105 from Merchant A). For example, any merchant may bid a percentage of a sale to a referred customer that will be provided to the referring merchant (e.g., based on one or more merchant defined bidding rules), and customers may be referred to merchants based on those bids. In some embodiments, merchants may establish and/or define bidding rules, for example in conjunction with establishment of merchant activity rules. For example, merchants may establish bidding rules substantially concurrently with establishment of an alliance with one or more other merchants. In other embodiments, merchants may establish and/or define bidding rules on-the-fly, for example when Merchant A is seeking bids for the referral of the additional customers 105. Thus, whether such bidding rules are pre-established or defined on-the-fly by a merchant, the system provider may determine a bid from each of a second merchant (e.g., Merchant B) and a third merchant (Merchant C) for the referral of the at least one customer (e.g., the customers 105) from Merchant A. As such, the system provider device 108 may be configured to credit a referring merchant account associated with a referring merchant (e.g., Merchant A), based at least partly on a transaction completed (e.g., a percentage of the purchase by the referred customer) at an allied merchant location (e.g., Merchant B) by a customer that was referred to the allied merchant by the referring merchant.

In some embodiments, the system provider may include a payment service provider such as, for example, PayPal Inc. of San Jose, Calif., that provides the customer sharing system 100 for the first merchant 102 at the first merchant location, the second merchant 104 at the second merchant location, and/or any other merchants participating in the customer sharing system 100. In some embodiments, the payment service provider establishes an alliance between the first and second merchants 102, 104, detects events associated with the first merchant 102 that satisfy one or more merchant activity rules, determines availability of the second merchant 104 to service one or more customers, and refers at least one customer at the first merchant location to the second merchant at the second merchant location. In some embodiments, as discussed below, the payment service provider processes payment requests from the first or second merchant 102, 104, processes payments from customers to the first or second merchant 102, 104, and may associate a merchant physical location (or its merchant such as merchant 102, 104), a customer location (or its customer), merchant devices, customer devices, and/or other components of the merchant alliance system 100 with a merchant account in a database located in a non-transitory memory. For example, the payment service provider may use a payment service provider device to transfer funds from a customer payment account (e.g., provided by an account provider through an account provider device, provided by the payment service provider through the payment service provider device, etc.) of the customer to a merchant payment account (e.g., provided by an account provider through an account provider device, provided by the payment service provider through the payment service provider device, etc.) of the merchant to provide payment from the customer to the merchant during a transaction.

Information sent and received through the network 106, merchant devices, and customer devices may be associated with first or second merchant 102, 104 accounts in the database, and any use of that information may be stored in association with such first or second merchant 102, 104 accounts. Furthermore, the payment service provider may provide the customer sharing system 100 for a plurality of different merchants at various merchant physical locations, similarly as described for the first and second merchants 102, 104 discussed below. Thus, references to a system provider operating a system provider device below may refer to a payment service provider operating a payment service provider device, or may refer to any other entity operating a customer sharing system separate from or in cooperation with a payment service provider.

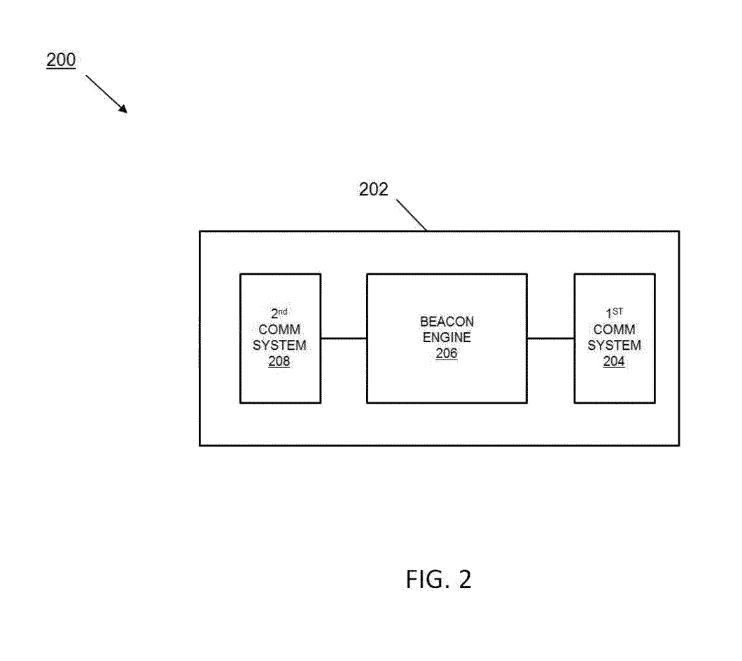

Referring now to FIG. 2, an embodiment of a beacon device 200 is illustrated. The beacon device 200 includes a chassis that houses a first communications system 204 such as, for example, a WiFi communications system. The first communications system 204 is coupled to a beacon engine 206 that may be provided by instruction on a memory system (not illustrated) in the beacon device 200 that, when executed by a processing system (not illustrated) in the beacon device 200, causes the processing system to perform the functions of the beacon device 200 discussed below. The beacon engine 206 is coupled to a second communication system 208 such as, for example, a Bluetooth® Low Energy (BLE) communication system. The beacon engine 206 may be configured to receive any of a variety of sensor signals through the second communication system 208 and transmit those sensor signals using the first communication system 204. While a few examples of communications components in the beacon device 200 have been described, one of skill in the art will recognize that other communications devices, as well as other components that have been omitted for clarity of discussion and illustrated, may be included in the beacon device 200 and will fall within the scope of the present disclosure. One of skill in the art will recognize that the components described above allow for the beacon device to be provided in a relatively small form factor such that it may be placed inconspicuously almost anywhere. As such, the chassis 202 of the beacon device 200 may include any of a variety of features that allow for the coupling of the beacon device to any part of a merchant physical location, such as a merchant physical location associated with the first or second merchant 102, 104.

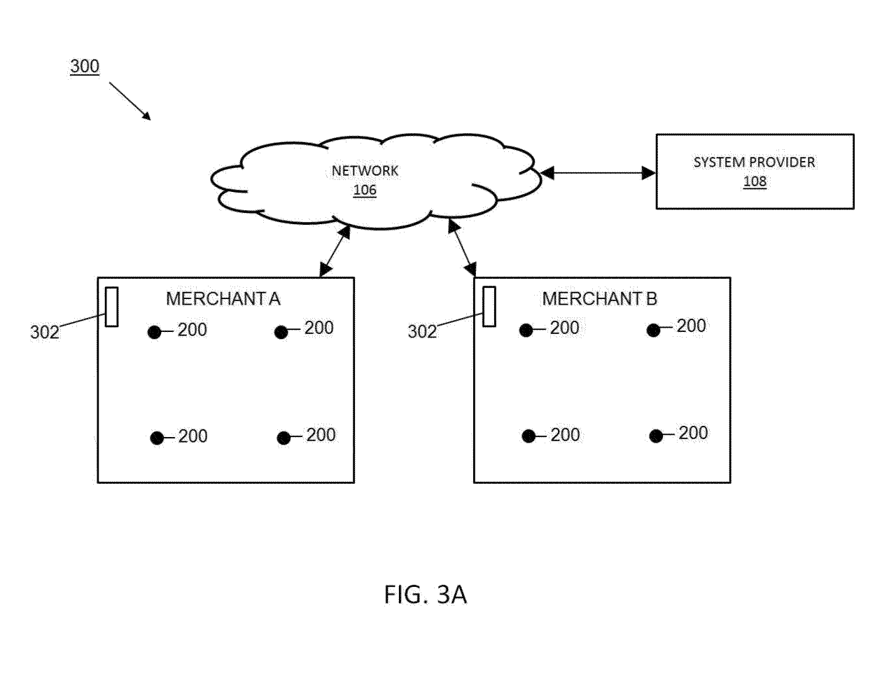

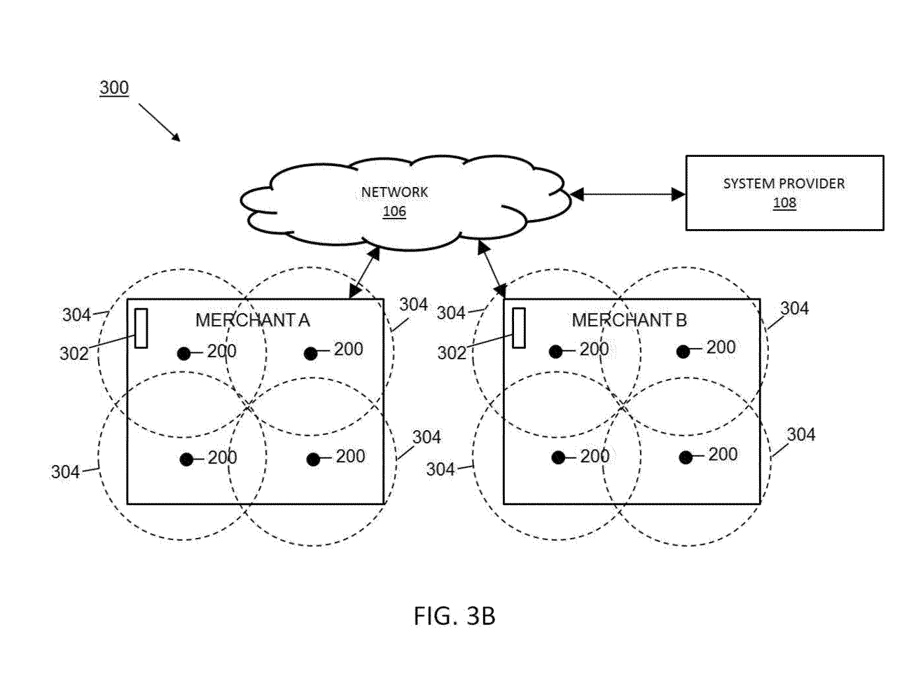

Referring now to FIGS. 3A and 3B, an embodiment of a customer sharing system 300 is illustrated. As illustrated in FIG. 3A, the customer sharing system 300 may be provided by positioning a plurality of the beacon devices 200, discussed above with reference to FIG. 2, in and around the merchant physical locations associated with the first merchant 102 and/or the second merchant 104, discussed above with reference to FIG. 1. As discussed above, the beacon devices 200 may be sized such that they may be inconspicuously positioned virtually anywhere in or around the merchant physical locations. For example, the beacon devices 200 may be positioned on a ceiling within various areas of an interior of the merchant physical locations and/or in any other part of the merchant physical locations associated with the first and second merchants 102, 104. Each of the beacon devices 200 in the merchant alliance system 300 may be configured to wirelessly communicate, via its first communications system 204, with a merchant network communication device 302 such as, for example, a WiFi wireless router connected to a network such as the Internet.

Referring now to FIG. 3B, in operation, each of the beacon devices 200 is configured to create a communication area 304 with its second communications system 208. For example, the second communications system 208 in each beacon device 200 may be a BLE communications device that provides an approximately 100 foot radius communications area. Depending on a desired coverage area, the power of individual beacon devices may be turned up or down to cover different sized areas, such that individual beacons within the location may have the same or different size coverage areas. However, other communications systems providing other communications areas are envisioned as falling within the scope of the present disclosure. As can be seen in the illustrated embodiment, the beacon devices 200 may be positioned in and around the merchant physical locations associated with the first and second merchants 102, 104 such that the communications areas 304 abut, overlap, or otherwise provide coverage for any area of interest within and around the merchant physical locations associated with the first and second merchants 102, 104. One of skill in the art in possession of the present disclosure will appreciate that different configurations of the beacon devices 200 within and around the merchant physical locations associated with the first and second merchants 102, 104 may be selected to cover any area within and around the merchant physical locations with a communications area 304.

As discussed in further detail below, each of the beacon devices 200 are configured to communicate with customer devices within their respective communications area 304 (e.g., using the second communication system 208) to collect information, and then send that information to the merchant network communication devices 302 (e.g., using the first communication system 204) such that the data may be provided to a merchant device, a system provider device, and/or any other device operating to provide the merchant alliance system discussed below. In an embodiment, each of the beacon devices 200 may communicate with a database at one or both of the merchant physical locations associated with the first and second merchants 102, 104 to retrieve real-time merchant and/or customer information, as discussed in further detail below.

In some of the figures associated with the embodiments discussed below, the beacon devices 200 and their communications areas 304 are not shown for the sake of clarity, but it should be understood that the communications and retrieval of information from beacon communication devices, and the provision of that information to a system provider device, may be accomplished using beacon devices providing communications areas such as the beacon devices 200 and communications areas 304 illustrated in FIGS. 3A and 3B. While a specific example of a customer sharing system 300 is provided, one of skill in the art in possession of the present disclosure will recognize that a wide variety of different merchant physical locations may incorporate the beacon devices 200 in a variety of different manners while remaining within its scope.

In the embodiments discussed below, the customer sharing systems and methods involve a system provider using a system provider device to detect events associated with a first merchant that satisfy one or more merchant activity rules by communicating, through the beacon devices 200, with customer devices and/or merchant devices at the merchant physical locations associated with the first and second merchants 102, 104. Additionally, availability of a second merchant to service one or more customers (e.g., also an event that may satisfy a merchant activity rule) may be determined by the system provider device, and the system provider device may refer customers based on the detection of events associated with the first merchant, the second merchant, and/or the customers that satisfy the one or more merchant activity rules. The system provider device may also store customer and/or merchant information (e.g., number of customers, number of transactions, rate of transactions, merchant physical location, customer physical location, etc.) in a database located at the merchant physical locations associated with the first and second merchants 102, 104 and/or the customers, or a remote database, for example, by way of a network connection. In some embodiments, the system provider device may be a merchant device that is local to one or both of the merchant physical locations associated with the first and second merchants 102, 104 and that communicates with the beacon devices 200 using the merchant network communication device 302. In other embodiments, the system provider may be, for example, a payment service provider as discussed above.

Furthermore, FIGS. 1, 3A, and 3B illustrate merchant physical locations associated with the first and second merchants 102, 104 where each physical location is a single building, with the beacon devices 200 positioned to provide communications areas 304 that cover the interior of that single building, a parking area of the single building, and/or outside sections of that single building. However, beacon devices 200 may be positioned virtually anywhere to retrieve information associated with a merchant physical location. For example, while beacon devices 200 may be positioned to provide coverage to portions of a parking area, throughout an entire parking lot, at the entrances or exits of that parking lot, and/or anywhere else relative to that parking lot in order to collect and send information from customer devices to the system provider device. In another example, the merchant physical location may be located in a mall, and beacon devices may be positioned around that mall, at the entrances or exits of that mall, and/or anywhere else relative to that mall in order to collect and send information from customer devices to the system provider device. In yet other examples, the merchant physical location may include a mobile location such as a food truck, cart, kiosk, trailer, and/or other mobile location as known in the art, and beacon devices may be positioned along an interior and/or exterior portion of such a mobile location, in a customer seating area of that mobile location, in a customer parking area of for that mobile location to provide coverage of the mobile location and/or surrounding areas. In some examples, the first communication system may be connected to WiFi networks available outside the merchant physical location in order to communicate collected information to a system provider device. In other examples, the first communication system may be a cellular communications system that allows the beacon devices to be positioned anywhere in range of a cellular communications tower, allowing beacon devices to be positioned in virtually any physical location when providing the customer sharing system. As such, the detection of events that satisfy merchant activity rules and/or the referral of one or more customers to a merchant may be performed, at least in part, based on customer actions that are performed outside a merchant physical location.

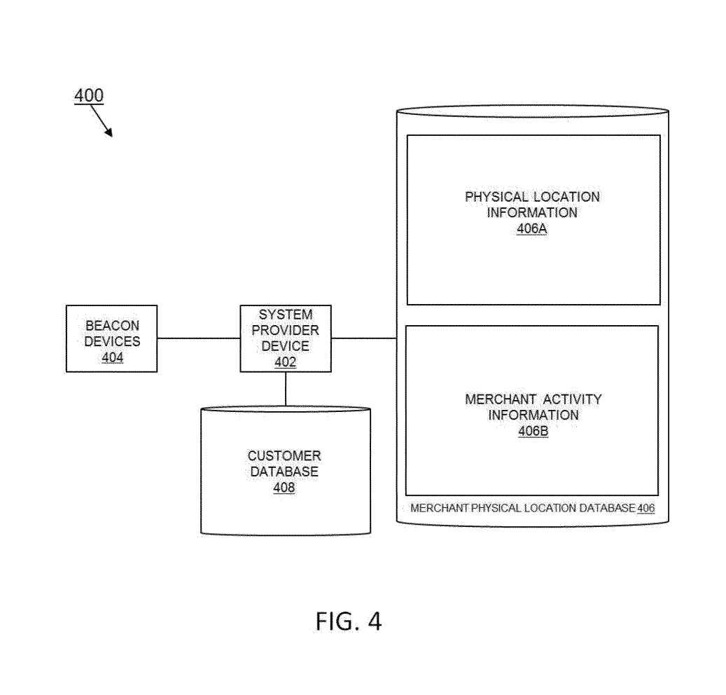

Referring to FIG. 4, an embodiment of a portion of a customer sharing system 400 is illustrated that may be used to implement one or more embodiments of the systems and methods of the present disclosure such as, for example, to detect events associated with a first merchant, second merchant, and/or customer that satisfy one or more merchant activity rules, as described below. The merchant alliance system 400 includes a system provider device 402 communicatively coupled to beacon devices 404 (which may be the beacon devices 200 discussed above), a merchant physical location database 406, and a customer database 408. While illustrated as single databases, the merchant physical location database 406 and customer database 408 may include multiple databases that may be located at the merchant physical locations associated with the first and/or second merchants 102, 104 and/or coupled to system provider device 402 by a network (e.g., the Internet).

In an embodiment, the merchant physical location database 406 may store merchant physical location information 406A and merchant activity information 406B. The merchant activity information may include for example, a number of customers, a number of transactions, a rate of transactions, a rate of revenue, social network check-ins, a list of potential customers (e.g., customers that have checked-in or which have been detected by the beacons 200), a list of allied merchants, transaction activity at allied merchants, a number of customers at allied merchants, and/or other merchant activity information as known in the art. In some examples, the merchant activity information may be updated in real-time as customers move into and out of the range of the beacons 200 at the merchant physical location, as transactions (e.g., purchases) are completed, as customers check-in, and/or as one or more merchant activity rules is satisfied. Furthermore, the customer database 408 may store customer information such as customer account information, customer purchase histories, allied merchants associated with customer purchases, customer preferences, customer wait times, and/or a variety of other customer information known in the art.

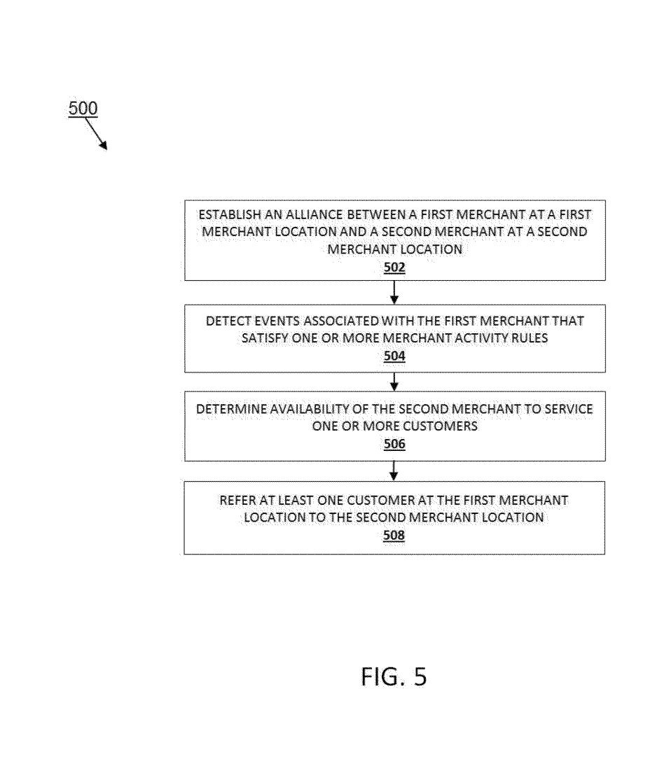

Referring now to FIG. 5, an embodiment of a method 500 for sharing customer traffic between merchants is illustrated. One of skill in the art in possession of the present disclosure will recognize that the method 500 may be performed for a plurality of different merchants at a variety of physical locations. In some examples, a network of allied merchants may be within walking distance of one another (e.g., within a few city blocks). In other examples, the network of allied merchants may be miles away, or even further, from each other. Some embodiments as described herein focus on providing customers with nearby allied merchants providing similar and/or complementary alternative products and/or services. However, other embodiments may provide customers with allied merchants which are further away, but which may offer incentives to customers (e.g., a certain percentage off their purchase) for shopping at the allied merchant. Similar customer incentives may be offered to customers even when the allied merchants are nearby (e.g., within walking distance).

The method 500 begins at block 502 where an alliance between a first merchant at a first location and a second merchant at a second location is established. In particular, with reference to FIGS. 6-8, a specific example of the method 500 is illustrated and described. Referring first to FIG. 6, a first merchant 602 (Merchant A) and a second merchant 604 (Merchant B) are shown. In the illustrated embodiment, the first and second merchants 602, 604 include food trucks. In one example, the first and second merchants 602, 604 offer competing food items (e.g., different types of breakfast, lunch, or dinner food items). In another example, the first and second merchants 602, 604 offer complementary food items (e.g., one merchant may offer a lunch or dinner food item, and the other merchant may offer a dessert food item). In the example of FIG. 6, each of the first and second merchants 602, 604 have setup their businesses near an office building 606 (e.g., during a lunch hour) to attract customers which may include individuals that work at the office building 606. Moreover, each of the first and second merchants 602, 604 have established and confirmed, for example by way of a system provider application and/or payment service provider application (e.g., a PayPal, Inc. application) executing on a merchant device, that they are allied with each other. In some examples, establishment of such a merchant alliance between the first and second merchant 602, 604 may include establishment of one or more merchant activity rules, establishment of referral fees, and/or other parameters and/or rules of the established merchant alliance. However, in some embodiments of the present disclosure, an alliance need not be established between the first merchant and the second merchant, and block 502 of the method 500 may be skipped.

As shown in FIG. 6, a plurality of customers 603 may be waiting for service at the first merchant 602 physical location. In some examples, customer devices (e.g., of the customers 603) are in communication with one or more beacon devices disposed at the first merchant 602 physical location such that the first merchant 602 and/or the system provider device are aware (e.g., through the payment service provider application executing on a merchant device) of a number of customers waiting for service. In one case, the first merchant 602 may have established a particular merchant activity rule that specifies when the number of customers waiting for service exceeds a particular number (e.g., five, as shown in the example of the customers 603 of FIG. 6), any additional customers may be referred to one or more allied second merchants (e.g., the allied second merchant 604 in the illustrated embodiment). In another case, the first merchant 602 may have established a particular merchant activity rule that specifies a particular customer wait time, over which one or more customers should be referred to the allied second merchant 604. In yet other examples, the first merchant 602 may have established a particular merchant activity rule that specifies a transaction rate (e.g., number of transactions (purchases) per minute), over which one or more customers should be referred to the allied second merchant 604. Another example of a merchant activity rule is one that enables the first merchant 602 to refer customers to the second merchant 604 before customers start waiting in line. For example, a rule can be based on a number of customers or potential customers entering an area (such as 10 yards from the merchant food truck) and a number of customers or potential customers exiting an area (such as the same 10 yard distance or from the point of sale area). When a specified difference between those numbers is reached, indicating high congestion or volume for the first merchant 602, referrals to the second merchant 604 may start when customers are detected entering the specified area. In some cases, the first merchant 602 may also manually refer one or more customers to the second merchant 604, whether or not events associated with the first merchant 602 are detected that satisfy one or more of the merchant activity rules. In some examples, when allied merchants (e.g., first and second merchants 602, 604) offer complementary products and/or services, customers may often visit one of the first or second merchants 602, 604 first, and may afterward visit the other merchant. For example, the system provider device (e.g., a payment service provider such as PayPal, Inc.) may access customer purchase histories, stored in the customer database 408 (FIG. 4), which allows for a determination that customers generally visit one of the allied merchants first, and then the other. Knowing this information, and in response to detecting event(s) that satisfy the one or more activity rules, the system provider device may alert waiting customers that they may first want to visit the second allied merchant (e.g., merchant 604), where the wait is shorter, and then return to the first allied merchant. Such swapping of the order of a customer typical visit to allied merchants allows those allied merchants to retain their customers, while increasing the number of customers served, and balancing customer traffic between the allied merchants. While a few examples of merchant activity rules that may be specified by the first merchant 602 have been described, one of skill in the art will recognize that other merchant activity rules specified by the second merchant and/or customers (as discussed above) may be implemented while remaining within the scope of the present disclosure.

The method 500 then proceeds to block 504 where events associated with the first merchant 602 that satisfy one or more merchant rules are detected. In a specific embodiment of block 504, and still referring to FIG. 6, potential customers 605 arrive at the first merchant 602 physical location. In some examples, when the potential customers 605 are near the first merchant 602 physical location, customer devices of the potential customers 605 may communicate with one or more beacon devices disposed at the first merchant 602 physical location. As such, the system provider device (e.g., the first merchant 602, a payment service provider, etc.) may be alerted that an event that satisfies a merchant activity rule (e.g., a number of customers waiting for service exceeds a particular number defined by the first merchant 602, the customers 605, etc.) has been detected. In other examples, potential customers (e.g., potential customers 605) may “check-in” to the first merchant 602 physical location via a payment service provider application (e.g., PayPal) and/or one or more social media applications (e.g., FourSquare, Google+, Facebook, Yelp, Twitter) executing on a customer device. As used herein, “check-in” is used to refer to self-reported positioning (e.g., by a customer), where an individual may self-report their presence at a physical location. In some examples, checking-in to a location may be accomplished by text messaging through a customer device, or by using a mobile application (e.g., social media application) executing on the customer device, where the mobile application uses a customer device's GPS receiver to determine the location of the customer device (and thus the location of the customer). In other examples, mobile applications executing on the customer device may provide a list of nearby places which are available for check-in. Thus, in the present example, in response to the potential customers 605 checking-in to the first merchant 602 location, the system provider may detect that a merchant activity rule has been satisfied by referencing check-in's to a location of a merchant (which may be indicative that a number of customers waiting for service exceeds a particular number).

The method 500 then proceeds to block 506 where availability of a second merchant to service one or more customers is determined. In a specific embodiment of block 506, and still referring to FIG. 6, once events associated with the first merchant 602 that satisfy one or more merchant rules (block 504) have been detected, the availability of an allied merchant (e.g., the second merchant 604) to service additional customers may be determined. As discussed above, in some embodiments, the ability to service additional customers (e.g., when a number of customers, a customer wait time, and/or a transaction rate) may be part of a merchant activity rule defined by the referred merchant. However, in some embodiments, merchant activity rules may be defined by the referring merchant and, upon satisfaction of those merchant activity rules, a determination may be made whether the referred merchant is available to service additional customers at block 506. The availability of an allied merchant to service additional customers may be determined by sharing merchant activity information 406B (e.g., stored in the merchant physical location database 406) with the system provider device 402. For example, allied merchants (e.g., first and second merchants 602, 604) may opt to share data collected from beacon devices 200 disposed at the merchant physical locations with the payment service provider. Moreover, allied merchants may opt to share beacon data (e.g., via the payment service provider) with other allied merchants, thus communicating real-time customer traffic conditions with each other. In other examples, allied merchants (e.g., first and second merchants 602, 604) may opt to share transaction activity information, such as a number of transactions, a rate of transactions, and/or other transaction information and/or other merchant information as known in the art. Allied merchants may also opt to share customer social network check-ins, a list of potential customers (e.g., customers that have checked-in or which have been detected by the beacons 200), customer purchase histories, customer preferences, and/or other customer information as known in the art. In various examples, any of the above merchant and/or customer information may be updated and shared with other allied merchants in real-time (e.g., as customers move into and out of the range of the beacons 200, as transactions are completed, as customers check-in, as merchant activity rules are satisfied, etc.). In the example of FIG. 6, by analyzing the shared merchant activity information 406B of the second merchant 604, the system provider device determines that the second merchant is currently only servicing one customer (customer 607) and is thus available to service additional customers.

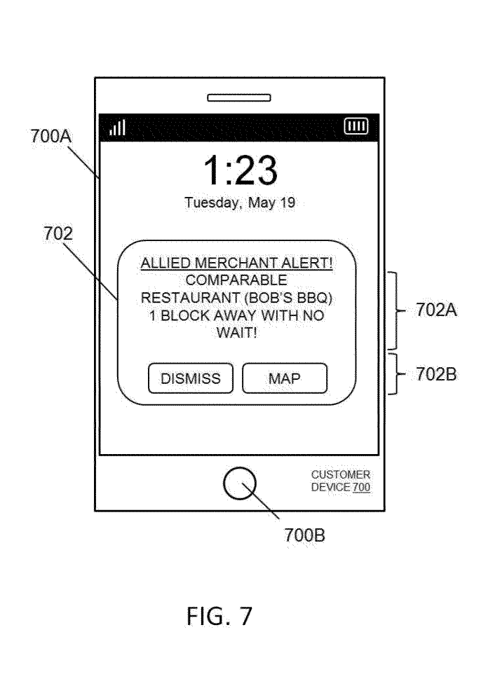

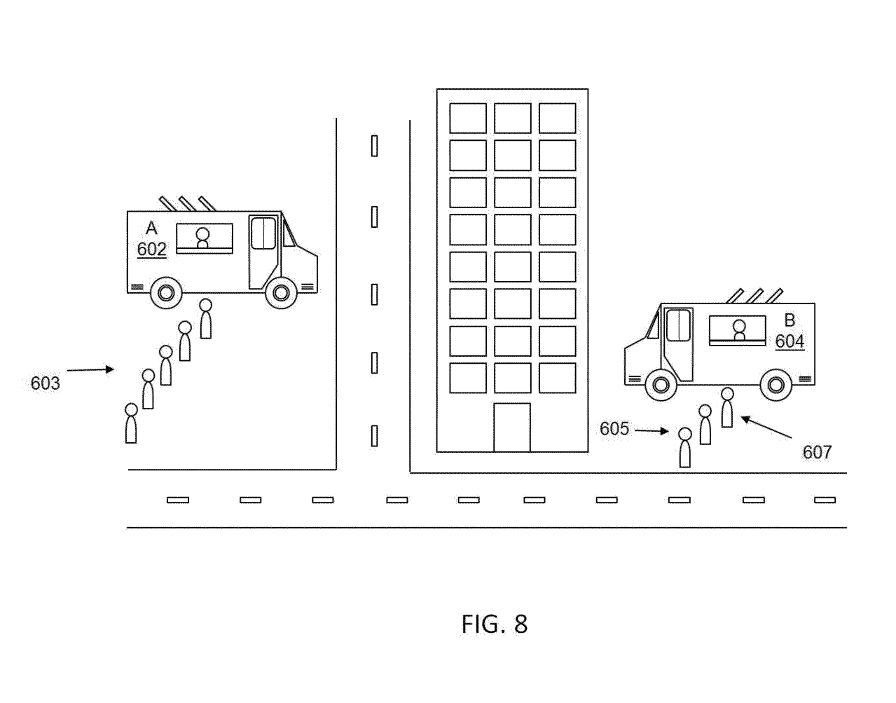

The method 500 then proceeds to block 508 where at least one customer at a first merchant location is referred to a second merchant location. In a specific embodiment of block 508, and referring to FIGS. 7 and 8, once an event associated with the first merchant 602 is detected that satisfies one or more merchant rules (block 504), and availability of an allied merchant to service additional customers has been determined (block 504 or 506), at least one of the customers 605 is referred to the second merchant 604. In one example, at least one of the customers 605 may be referred to the second merchant 604 by way of a message delivered to a customer device belonging to the at least one customer 605, as described below. The message may be delivered for example, by the system provider device, in response to detecting the event that satisfies the one or more activity rules, and in some situations based on the availability of an allied second merchant. FIG. 7 illustrates an example of a customer device 700 including a display 700A and an input button 700B. While the customer device 700 is illustrated and described as a mobile phone, a variety of other customer devices are envisioned as falling within the scope of the present disclosure. In the illustrated embodiment, the customer device 700 is displaying an allied merchant alert 702 that provides the customer (e.g., at least one of the customers 605) associated with the customer device 700 with a notification of at least one available merchant that is allied (e.g., the merchant 604) to the merchant at the location where the customer is currently located (e.g., the merchant 602). In one example, the customer device 700 may include a system provider application and/or a payment service provider application (e.g., a PayPal, Inc. application) which may be launched by the customer and that provides for the functionality of the customer device 700 discussed below. In another example, the system provider application and/or a payment service provider application may be launched automatically upon entering a merchant physical location (e.g., in response to communication with the beacon devices 200). In the illustrated embodiment, the allied merchant alert 702 includes an allied merchant information section 702A and buttons 702B, which may for example include a dismiss/ignore message button, a more information button, a map button, and/or other buttons for allowing a customer to access additional information regarding the allied merchant. Additionally, in various embodiments, the merchant information section 702A may further include a merchant name, a merchant rating, a merchant distance, a merchant wait time, a merchant offer (e.g., 10% off purchases for the next hour), and/or other merchant information as known in the art. In some embodiments, the system provider and/or payment service provider application may provide the allied merchant alert 702 immediately; however, in other embodiments, the customer may be required to provide authentication credentials in order to access the allied merchant alert 702.

In the example illustrated in FIG. 7, a customer (e.g., at least one of the customers 605) has received an allied merchant alert 702 letting the customer know that there is a comparable restaurant (e.g., the allied merchant 604) located one block away, and there is currently no wait for service. The customer may thus decide to visit the allied merchant 604 rather than wait in a long line for service at the merchant 602. Continuing with the example, and with reference to FIG. 8, in response to receiving the allied merchant alert 702, the customers 605 decided to walk one block over to the allied merchant 604. In some embodiments, before the customers 605 leave the first merchant 602 physical location (in some cases before the allied merchant alert 702 is provided to the customer), the payment service provider may push data to customer devices (of the customers 605) to indicate that the customers 605 were first at the first merchant 602 physical location. Thereafter, if the customers 605 subsequently make a purchase at the allied merchant to which they were referred (e.g., the merchant 604), then the first merchant 602 may be entitled to a referral fee from the second merchant 604 based on any transaction with the referred customers 605, which may be credited to a merchant account associated with the first merchant 602. In other embodiments, allied merchants may agree on and implement any other type of agreement, and as desired and/or suitable to particular merchant types, based on the referral of customers and/or on referred customers that subsequently make purchases. In one embodiment, when the customers 605 subsequently make a purchase at the second merchant 604 location, the payment service provider will determine, for example via the data previously pushed to the customer devices, whether the customers 605 were previously at, and referred by, an allied merchant (e.g., the allied merchant 602). In the present example, since the customers 605 were previously at the allied merchant 602 location, and because they were referred by the first merchant 602 to the second merchant 604, the merchant account associated with the first merchant 602 will be credited as described above. In some examples, when the customers 605 approach the second merchant 604 physical location, customer devices of the customers 605 may communicate with one or more beacon devices disposed at the second merchant 604 physical location. As such, the payment service provider may determine, for example via the data previously pushed to the customer devices and via the customer device communication with the beacon devices, whether the customers 605 were previously at, and referred by, an allied merchant (e.g., the allied merchant 602.

While a specific example of the method 500 for sharing customer traffic between allied merchants has been shown and described, one of skill in the art will recognize that other methods and techniques may be included in the method 500, while remaining within the scope of the present disclosure. For example, in some embodiments, the method 500 may include a step of recognizing groups of customers that are traveling together. In some embodiments, when a group of customer devices enters a beacon communication area 304 (of a particular merchant) at substantially the same time or in a manner that is otherwise indicative of those customer devices belonging to a group of customers that are together, location histories of the customer devices may be analyzed by the service and/or payment service provider to determine for example, whether the customer devices share a significant common location history prior to entering the beacon communication area 304 (e.g., those customer devices are often co-located during lunchtime). For example, the service and/or payment service provider may analyze a specific timeframe (e.g., the last 10 minutes) of the customer devices' location histories to determine whether the customer devices (and thus their associated customers) have spent time together prior to entering the beacon communication area 304. In one case, a group of people walking together from the office building 606 to have lunch at the same food truck (e.g., one of the merchants 602, 604) would be determined by the system and/or payment provider as a group of customer devices having a significant location history. In some examples, the system and/or payment service provider may also analyze personal calendars of a group of customers, as accessed via the customer devices, to determine whether the group of customers had the same and/or overlapping appointments to meet at a particular location at a particular time (e.g., lunch at a restaurant at 12:30 pm).

By way of example, consider a group of three individuals who have completed a meeting together at the office building 606 and decide to go out to lunch together to the first merchant location (Merchant A). When the group of three potential customers approach a beacon communication area 304 at the Merchant A physical location, the system and/or payment service provider may not only determine their presence at the Merchant A physical location, but also analyze their calendars and location histories (as described above) to determine that the group of three individuals constitutes a “customer group” that should remain together. In one example, event(s) associated with Merchant A are detected that satisfy one or more merchant rules, as described above. In response, the system and/or payment service provider searches for allied merchants that are available to service more customers. In the present example, Merchant A determines that there are two nearby, allied merchants (Merchant B and Merchant C). In one case, the system and/or payment service provider determines that Merchant B is available to service one additional customer, while Merchant C is available to service five additional customers. The service provider, recognizing that the customer group of three individuals should stay together, would thereby refer the customer group to Merchant C. In one example, any or all of the customers of the customer group would receive an allied merchant alert 702, directing each member of the group to Merchant C, and keeping the customer group together. In some embodiments, if both Merchant B and Merchant C are available to service the entire customer group, then the Merchants B and C may bid on the customer group, in order to win the customer referral from the Merchant A. In one embodiment, such a bidding process between allied merchants may include offering competing incentives to the referring merchant (e.g., Merchant A), such as offering a higher percentage of any purchases made by the customer group, or by any individual member of the customer group. Such a bidding process between allied merchants may provide for the establishment of a miniature market within the allied merchant ecosystem.

In other examples, the method 500 may further include a step of discovering potential merchants to ally with each other. For example, consider a particular busy merchant (Merchant A, with high merchant activity) that is consistently losing customers, for example as determined by customers who walk into a beacon communication area 304 and leave the beacon communication area 304 after a period of time without making a purchase. In such an example, there may be an opportunity for the busy merchant (Merchant A) to refer customer traffic to another merchant (Merchant B) that is monitored, for example by the system and/or payment service provider, to have low customer traffic and/or low merchant activity (e.g., particularly during the time in which Merchant A has been detected losing customers). Such an embodiment would allow merchants to keep customer levels substantially steady and/or improve revenues (e.g., based on referral fees). Furthermore, recognizing and forming such an alliance may also further help the particular busy merchant (Merchant A) during periods of reduced customer traffic, when a now busy Merchant B may refer customers to Merchant A.

Thus, systems and methods have been described that provide for the sharing of customer traffic between merchants. In particular, the systems and methods described herein provide for allied merchants to maintain a more steady stream of customers by referring customers at busy merchants (e.g., having long wait times) to more available merchants (e.g., having comparably shorter wait times), thus improving customer experiences while keeping customers within an allied merchant ecosystem. In response to detecting events that satisfy one or more merchant activity rules, and in some cases additionally based on the availability of an allied second merchant to provide service to additional customers, the one or more customers may be referred from the first merchant to the allied second merchant. In some examples, the first merchant may receive incentives (a percentage of) purchases made at the allied second merchant in return for the customer referral. Thus, in accordance with the various embodiments described herein, allied merchants may be able to avoid spikes of busy/slow times and instead maintain a steady stream of customer traffic.

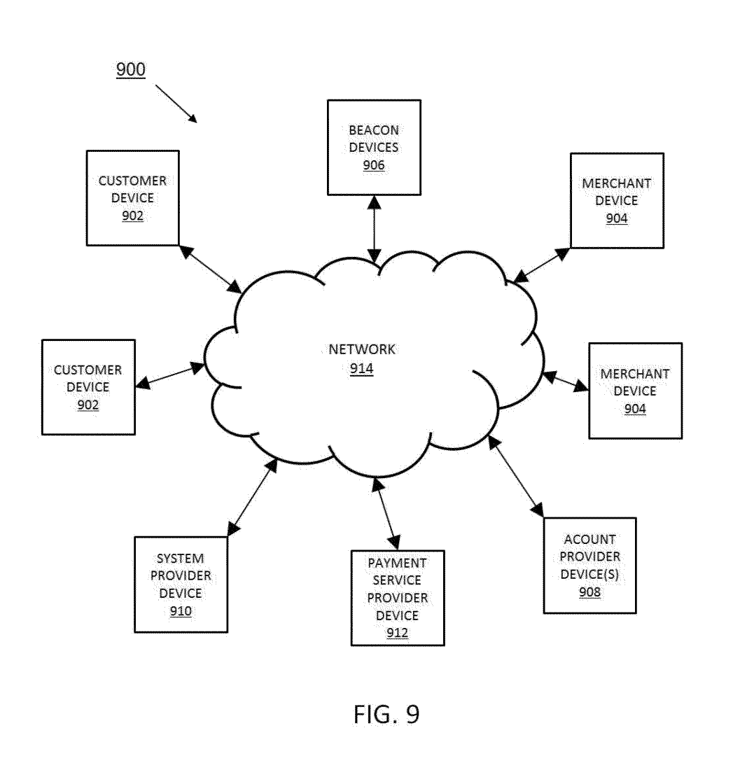

Referring now to FIG. 9, an embodiment of a network-based system 900 for implementing one or more processes described herein is illustrated. As shown, the network-based system 900 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 9 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 900 illustrated in FIG. 9 includes a plurality of customer devices 902, a plurality of merchant devices 904, a plurality of beacon devices 906, a payment service provider device 912, account provider device(s) 908, and/or a system provider device 910 in communication over one or more networks 914. The customer devices 902 may be the customer devices discussed above and may be operated by the customers discussed above. The merchant devices 904 and beacon devices 906 may be the merchant devices and beacon devices discussed above and may be operated by the merchants discussed above. The payment service provider device 912 may be the payment service provider devices discussed above and may be operated by a payment service provider such as, for example, PayPal Inc. of San Jose, Calif. The system provider devices 910 may be the system provider devices discussed above and may be operated by the system providers discussed above. The account provider devices 908 may be operated by credit card account providers, bank account providers, savings account providers, and a variety of other account providers known in the art.

The customer devices 902, merchant devices 904, beacon devices 906, payment service provider device 912, account provider devices 908, and/or system provider device 910 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 900, and/or accessible over the network 914.

The network 914 may be implemented as a single network or a combination of multiple networks. For example, in various embodiments, the network 914 may include the Internet and/or one or more intranets, landline networks, wireless networks, and/or other appropriate types of networks.

The customer devices 902 may be implemented using any appropriate combination of hardware and/or software configured for wired and/or wireless communication over network 914. For example, in one embodiment, the customer devices 902 may be implemented as a personal computer of a user in communication with the Internet. In other embodiments, the customer devices 902 may be a smart phone, wearable computing device, laptop computer, and/or other types of computing devices.

The customer devices 902 may include one or more browser applications which may be used, for example, to provide a convenient interface to permit the customer to browse information available over the network 914. For example, in one embodiment, the browser application may be implemented as a web browser configured to view information available over the Internet.

The customer devices 902 may also include one or more toolbar applications which may be used, for example, to provide user-side processing for performing desired tasks in response to operations selected by the customer. In one embodiment, the toolbar application may display a user interface in connection with the browser application.

The customer devices 902 may further include other applications as may be desired in particular embodiments to provide desired features to the customer devices 902. In particular, the other applications may include a payment application for payments assisted by a payment service provider through the payment service provider device 912. The other applications may also include security applications for implementing user-side security features, programmatic user applications for interfacing with appropriate application programming interfaces (APIs) over the network 914, or other types of applications. Email and/or text applications may also be included, which allow customer payer to send and receive emails and/or text messages through the network 914. The customer devices 902 includes one or more user and/or device identifiers which may be implemented, for example, as operating system registry entries, cookies associated with the browser application, identifiers associated with hardware of the customer devices 902, or other appropriate identifiers, such as a phone number. In one embodiment, the user identifier may be used by the payment service provider device 912 and/or account provider device 908 to associate the user with a particular account as further described herein.

The merchant devices 904 may be maintained, for example, by a conventional or on-line merchant, conventional or digital goods seller, individual seller, and/or application developer offering various products and/or services in exchange for payment to be received conventionally or over the network 914. In this regard, the merchant device 904 may include a database identifying available products and/or services (e.g., collectively referred to as items) which may be made available for viewing and purchase by the customer.

The merchant devices 904 also include a checkout application which may be configured to facilitate the purchase by the payer of items. The checkout application may be configured to accept payment information from the user through the customer devices 902, the account provider through the account provider device 908, and/or from the payment service provider through the payment service provider device 912 over the network 914.

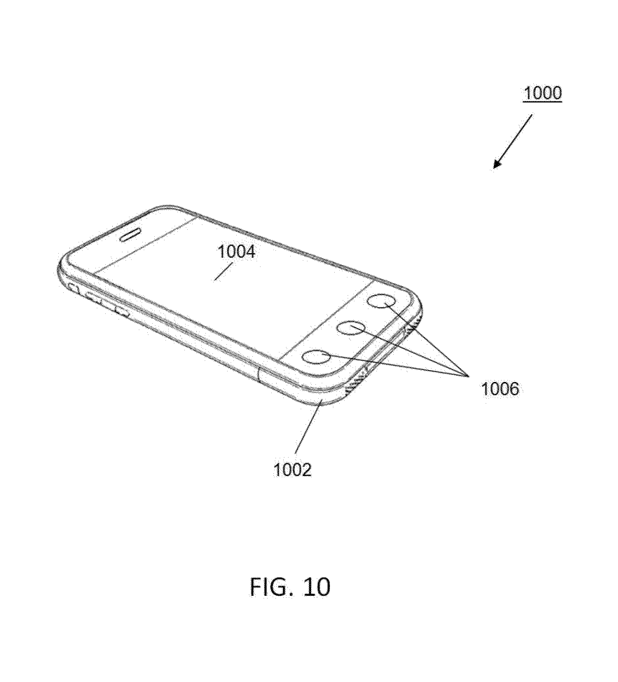

Referring now to FIG. 10, an embodiment of a customer device 1000 is illustrated. The customer device 1000 may be the customer device 700 or 902 discussed above. The customer device 1000 includes a chassis 1002 having a display 1004 and an input device including the display 1004 and a plurality of input buttons 1006. One of skill in the art will recognize that the customer device 1000 is a portable or mobile phone including a touch screen input device and a plurality of input buttons that allow the functionality discussed above with reference to the methods above. However, a variety of other portable/mobile customer devices and/or desktop customer devices may be used in the methods discussed above without departing from the scope of the present disclosure.

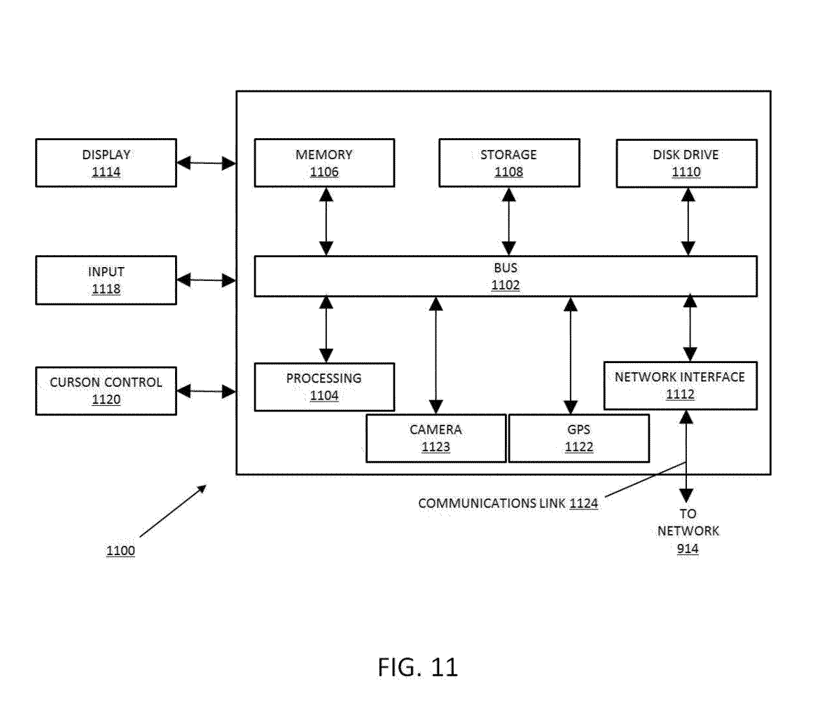

Referring now to FIG. 11, an embodiment of a computer system 1100 suitable for implementing, for example, the customer device 700 or 902, merchant device 904, beacon devices 200, 404, or 906, payment service provider device 912, account provider device(s) 908, and/or system provider devices 402 or 910, is illustrated. It should be appreciated that other devices utilized by customers, merchants, beacon devices, merchant beacon communication devices, payment service providers, account provider device(s), and/or system providers in the system discussed above may be implemented as the computer system 1100 in a manner as follows.

In accordance with various embodiments of the present disclosure, computer system 1100, such as a computer and/or a network server, includes a bus 1102 or other communication mechanism for communicating information, which interconnects subsystems and components, such as a processing component 1104 (e.g., processor, micro-controller, digital signal processor (DSP), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), a location determination component 1122 (e.g., a Global Positioning System (GPS) device as illustrated, a cell tower triangulation device, and/or a variety of other location determination devices known in the art), and/or a camera component 1123. In one implementation, the disk drive component 1110 may comprise a database having one or more disk drive components.

In accordance with embodiments of the present disclosure, the computer system 1100 performs specific operations by the processor 1104 executing one or more sequences of instructions contained in the memory component 1106, such as described herein with respect to the customer devices 700 or 902, merchant device 904, beacon devices 200, 404, or 906, payment service provider device 912, account provider device(s) 908, and/or system provider devices 402 or 910. Such instructions may be read into the system memory component 1106 from another computer readable medium, such as the static storage component 1108 or the disk drive component 1110. In other embodiments, hard-wired circuitry may be used in place of or in combination with software instructions to implement the present disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1100. In various other embodiments of the present disclosure, a plurality of the computer systems 1100 coupled by a communication link 1124 to the network 914 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

Referring now to FIG. 12, an embodiment of a system provider device 1200 is illustrated. In an embodiment, the device 1200 may be the system provider devices discussed above. The device 1200 includes a communication engine 1202 that is coupled to the network 914 and to a customer sharing engine 1204 that is coupled to a customer information database 1206 and a merchant information database 1208. The communication engine 1202 may be software or instructions stored on a computer-readable medium that allows the device 1200 to send and receive information over the network 914. The customer sharing engine 1204 may be software or instructions stored on a computer-readable medium that, when executed by a processor, is configured to establish merchant alliances, determine compliance by a first merchant with one or more activity rules, determine availability of a second merchant to service one or more customers, referring one or more customers from the first merchant location to the second merchant location, as well as provide any of the other functionality that is discussed above. While the databases 1206 and 1208 have been illustrated as located in the device 1200, one of skill in the art will recognize that they may be connected to the customer sharing engine 1204 through the network 914 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
at least one non-transitory memory storing merchant information; and
one or more hardware processors that are coupled to the at least one non-transitory memory and that are configured to read instructions from the at least one non-transitory memory to perform the steps of:
determining at least one customer is at a first merchant location;
detecting an event that is associated with a first merchant at the first merchant location and that satisfies one or more merchant activity rules;
determining an availability of a second merchant at a second merchant location to service one or more customers; and
referring, based on the detected event that is associated with the first merchant and that satisfies the one or more merchant activity rules, and on the availability of the second merchant, the at least one customer at the first merchant location to the second merchant at the second merchant location.

2. The system of claim 1, wherein determining the at least one customer is at the first merchant location is through at least one beacon at the first merchant location.

3. The system of claim 1, wherein the one or more hardware processors are further configured to read instructions from the at least one non-transitory memory to perform the steps of:
detecting the event that is associated with the first merchant and that satisfies the one or more merchant activity rules;
determining a bid from each of the second merchant and a third merchant for the referral of the at least one customer; and
referring the at least one customer to the second merchant or third merchant based on the bids received from each of the second merchant and the third merchant.

4. The system of claim 1, wherein the one or more hardware processors are further configured to read instructions from the at least one non-transitory memory to perform the steps of:
processing a transaction between the at least one customer and the second merchant; and
crediting a first merchant account associated with the first merchant with a percentage of an amount of the transaction.

5. The system of claim 1, wherein the one or more hardware processors are further configured to read instructions from the at least one non-transitory memory to perform the steps of:
alerting the first merchant in response to detecting the event that satisfies the at least one merchant activity rule; and
receiving a manual referral, from the first merchant, of the at least one customer at the first merchant location to the second merchant at the second merchant location.

6. The system of claim 1, wherein the determining the availability of the second merchant to service one or more customers further comprises retrieving, from the second merchant, at least one of merchant activity information, data collected from beacon devices, transaction activity information, and customer information.

7. The system of claim 1, wherein the referring the at least one customer at the first merchant location to the second merchant at the second merchant location further comprises providing an allied merchant alert to a customer device associated with the at least one customer.

8. The system of claim 1, wherein the first merchant location is a dynamic area determined by the first merchant.

9. The system of claim 1, wherein the one or more hardware processors are further configured to read instructions from the at least one non-transitory memory to perform the steps of:
analyzing location histories of a plurality of customers at the first merchant location to determine that the plurality of customers includes a customer group at the first merchant location;
determining the availability of the second merchant to service the customer group; and
referring, based on the detected event that is associated with the first merchant and that satisfies the one or more merchant activity rules, and on the availability of the second merchant to service the customer group, the customer group at the first merchant location to the second merchant at the second merchant location.

10. The system of claim 1, wherein the one or more hardware processors are further operable to read instructions from the at least one non-transitory memory to perform the steps of:
monitoring customer traffic of both the first merchant at the first merchant location and the second merchant at the second merchant location; and
determining that the first merchant has a merchant activity that is higher than the second merchant.

11. A method, comprising:
detecting, by a system provider device through a network, an event that is associated with a first merchant at a first merchant location and that satisfies one or more merchant activity rules;
determining, by the system provider device, an availability of a second merchant at a second merchant location to service one or more customers; and
referring, by the system provider device, based on the detected event that is associated with the first merchant and that satisfies the one or more merchant activity rules, and on the availability of the second merchant, at least one customer at the first merchant location to the second merchant at the second merchant location.

12. The method of claim 11, further comprising:
detecting, by the system provider device, the event that is associated with the first merchant and that satisfies the one or more merchant activity rules;
determining, by the system provider device, a bid from each of the second merchant and a third merchant for the referral of the at least one customer; and
referring, by the system provider device, the at least one customer to the second or third merchant based on the bids received from each of the second merchant and the third merchant.

13. The method of claim 11, further comprising:
processing, by the system provider device, a transaction between the at least one customer and the second merchant; and
crediting, by the system provider device, a first merchant account associated with the first merchant with a percentage of an amount of the transaction.

14. The method of claim 11, wherein the determining, by the system provider device, the availability of the second merchant to service one or more customers further comprises retrieving, from the second merchant, at least one of merchant activity information, data collected from beacon devices, transaction activity information, and customer information.

15. The method of claim 11, wherein locations of customers at the first merchant location are detected through at least one beacon at the first merchant location.

16. The method of claim 11, further comprising:
analyzing, by the system provider device, location histories of a plurality of customers at the first merchant location to determine that the plurality of customers includes a customer group at the first merchant location;
determining, by the system provider device, the availability of the second merchant to service the customer group; and
referring, by the system provider device, based on the detected event that is associated with the first merchant and that satisfies the one or more merchant activity rules, and on the availability of the second merchant to service the customer group, the customer group at the first merchant location to the second merchant at the second merchant location.

17. A non-transitory machine-readable medium comprising a plurality of machine-readable instructions executable by one or more processors to cause the one or more processors to perform a method comprising:
detecting at least a customer at a first merchant location;
accessing merchant activity rules for a first merchant associated with the first merchant location;
determining at least one of the merchant activity rules is satisfied;
determining an availability of a second merchant at a second merchant location to service the customer; and
communicating a referral of the second merchant at the second merchant location to a device of the customer at the first merchant location based, at least in part, on the at least one satisfied merchant activity rule.

18. The non-transitory machine-readable medium of claim 17, wherein the method further comprises:
processing a transaction between the customer and the second merchant; and
crediting a first merchant account associated with the first merchant with a percentage of an amount of the transaction.

19. The non-transitory machine-readable medium of claim 17, wherein the method further comprises:
prior to referring the customer at the first merchant location to the second merchant at the second merchant location, sending data to the device of the customer that indicates the customer was referred by the first merchant.

20. The non-transitory machine-readable medium of claim 17, wherein the method further comprises:
analyzing location histories of a plurality of customers at the first merchant location to determine that the plurality of customers includes a customer group at the first merchant location;
determining the availability of the second merchant to service the customer group; and
referring, based on the detected event that is associated with the first merchant and that satisfies the one or more merchant activity rules, and on the availability of the second merchant to service the customer group, the customer group at the first merchant location to the second merchant at the second merchant location.
